(19) United States
(12) Patent Application Publication
(10) Pub. No.: US 2021/0215052 A1
(43) Pub. Date: Jul. 15, 2021

(54) TURBINE IMPELLER

(71) Applicant: IHI Corporation, Tokyo (JP)

(72) Inventors: Yoshimitsu MATSUYAMA, Tokyo (JP); Yukio TAKAHASHI, Tokyo (JP); Atsushi HIRATA, Tokyo (JP); Kazuo MIYOSHI, Tokyo (JP); Kenichi TAKAHASHI, Tokyo (JP); Daisuke WADA, Tokyo (JP); Yasuhiro RAI, Tokyo (JP)

(73) Assignee: IHI Corporation, Tokyo (JP)

(21) Appl. No.: 17/059,844

(22) PCT Filed: Jun. 6, 2019
(86) PCT No.: PCT/JP2019/022605

§ 371 Date: Nov. 30, 2020

(30) Foreign Application Priority Data
Jun. 6, 2018 (JP) 2018-108918

(51) Int. Cl. F01D 5/28; F01D 25/00

(52) U.S. Cl. CPC F01D 5/288; F05D 2230/31; F05D 2240/30; F01D 25/007

(57) ABSTRACT

A turbine impeller includes: a base material which contains aluminum as a main element; and an anti-erosion coating which covers a surface of the base material. Accordingly, since liquid droplets hit the anti-erosion coating before the base material even when the liquid droplets flow into the rotating turbine impeller, the damage to the base material due to erosion is suppressed.

### TECHNICAL FIELD

The present disclosure relates to a turbine impeller.

### BACKGROUND ART

For example, a turbine impeller rotates around an axis by receiving a flow of a working medium. Patent Literature 1 discloses a technique for applying a coating treatment on a turbine impeller as a countermeasure for erosion. The technique of Patent Literature 1 forms a physical vapor deposition hard layer on a nitride hard layer as a coating treatment.

### CITATION LIST

### Patent Literature

Patent Literature 1: International Publication WO 2007/083361

### SUMMARY OF INVENTION

### Technical Problem

The turbine impeller has been required to be rotated at a higher speed. Accordingly, aluminum has been examined as a base material of the turbine impeller. For example, a working medium containing liquid droplets may flow into the turbine impeller in an emergency. In this case, there is a risk that the turbine impeller may be damaged due to erosion. The present disclosure describes a turbine impeller capable of suppressing damage to the turbine impeller due to erosion.

### Solution to Problem

A turbine impeller according to an aspect of the present disclosure includes: a base material which contains aluminum as a main element; and an anti-erosion coating which covers a surface of the base material.

### Effects of Invention

According to the present disclosure, the damage to the turbine impeller due to erosion is suppressed.

### BRIEF DESCRIPTION OF DRAWINGS

FIG. 1 is a diagram illustrating a schematic configuration of a binary power generator including a turbine impeller of an embodiment of the present disclosure.

FIG. 2 is a partially cross-sectional view of a turbine generator illustrated in FIG. 1.

FIG. 3 is a cross-sectional view of the turbine impeller illustrated in FIG. 2.

FIG. 4 is a cross-sectional view illustrating a coating formed on a surface of a base material.

### DESCRIPTION OF EMBODIMENTS

A turbine impeller according to an aspect of the present disclosure includes: a base material which contains aluminum as a main element; and an anti-erosion coating which covers a surface of the base material.

The turbine impeller of the present disclosure is provided with the anti-erosion coating. As a result, when liquid droplets flow into the turbine impeller, the liquid droplets hit the anti-erosion coating before the base material. Thus, the damage to the surface of the base material due to erosion is suppressed.

The anti-erosion coating may be a plating layer containing nickel and phosphorus. Accordingly, the hardness of the anti-erosion coating can be made higher than the hardness of the base material. According to the anti-erosion coating having high hardness, the damage to the turbine impeller due to erosion can be suppressed.

The hardness of the base material may be a Vickers hardness HV100 or more and HV160 or less. The hardness of the anti-erosion coating may be a Vickers hardness HV500 or more.

A through-hole may be formed in the base material to penetrate in an axial direction. The anti-erosion coating may not be formed on an end surface of the base material in the axial direction. According to this configuration, a surface roughness of the end surface of the base material can be easily managed. For example, a rotation shaft includes a rotation shaft main body and a bar-shaped member having a diameter smaller than that of the rotation shaft main body. According to this configuration, the bar-shaped member is inserted through the through-hole, the base end portion of the bar-shaped member is connected to the rotation shaft main body, and a nut can be fastened to a screw portion of a tip portion of the bar-shaped member. The turbine impeller is pressed against the rotation shaft main body by the nut and the turbine impeller can be attached to the rotation shaft. According to this configuration, the surface roughness of the end surface of the turbine impeller can be easily controlled to a design value. As a result, an appropriate frictional force can be generated between the end surface of the turbine impeller and a surface in close contact with the end surface. Thus, the displacement of the turbine impeller with respect to the rotation shaft can be suppressed.

A through-hole may be formed in the base material to penetrate in an axial direction. The anti-erosion coating may not be formed on an inner peripheral surface of the through-hole. According to this configuration, the dimension of the inner peripheral surface of the through-hole can be easily managed. When the dimension of the inner peripheral surface of the through-hole is easily managed, it is possible to suppress a decrease in fitting accuracy of the through-hole and the rod-shaped member inserted through the through-hole.

Hereinafter, an embodiment of the present disclosure will be described in detail with reference to the drawings. It should be noted that the same parts or the corresponding parts in the drawings will be denoted by the same reference numerals. Redundant description will be omitted.

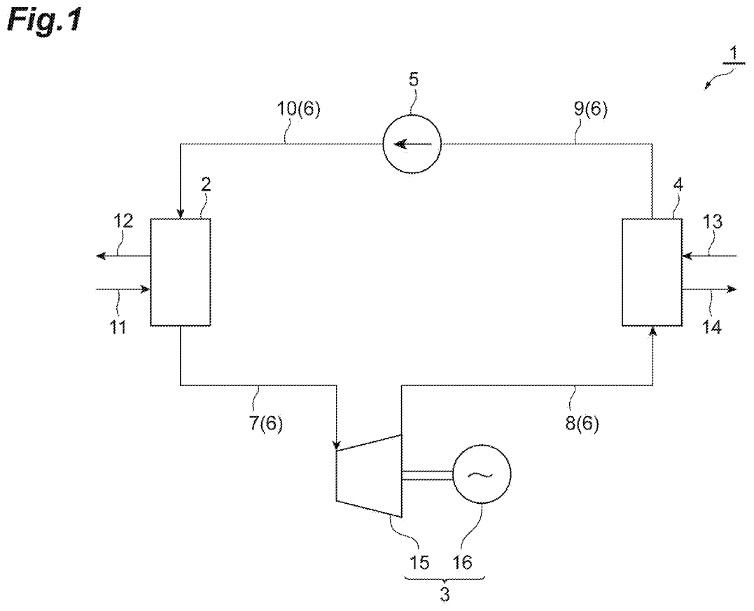

A binary power generator 1 illustrated in FIG. 1 is a system that generates power. The binary power generator 1 uses, for example, hot water as a heat source. The binary power generator 1 is installed in, for example, a factory or the like. The binary power generator 1 may be installed in, for example, an incineration facility, a boiler facility, a hot spring facility, a geothermal power plant, and other waste heat utilization facilities. The binary power generator 1 adopts, for example, an Organic Rankine Cycle (ORC). The binary power generator 1 exchanges heat between a heat source and a working medium. The boiling point of the working medium used in the binary power generator 1 is lower than that of the water. The working medium is, for example, a CFC substitute or the like. As the working medium, for example, an inert gas may be used. Other fluids may be used as the working medium.

The binary power generator 1 includes an evaporator 2, a turbine generator 3 (an expansion generator), a condenser 4, and a circulation pump 5. The binary power generator 1 includes a circulation line 6. The circulation line 6 connects the evaporator 2, the turbine generator 3, the condenser 4, and the circulation pump 5. The circulation line 6 includes a first pipe 7, a second pipe 8, a third pipe 9, and a fourth pipe 10. The first pipe 7 connects the evaporator 2 to the turbine generator 3. The second pipe 8 connects the turbine generator 3 to the condenser 4. The third pipe 9 connects the condenser 4 to the circulation pump 5. The fourth pipe 10 connects the circulation pump 5 to the evaporator 2. The working medium passes through the circulation line 6. The working medium circulates in devices such as the evaporator 2, the turbine generator 3, the condenser 4, and the circulation pump 5.

The evaporator 2 is a heat exchanger. The evaporator 2 evaporates the working medium by the heat of the heat source. As the evaporator 2, for example, a plate type heat exchanger can be used. The evaporator 2 is not limited to the plate type heat exchanger. The evaporator 2 may be a shell-and-tube heat exchanger. The evaporator 2 may be a heat exchanger of another type. A pipe 11 and a pipe 12 are connected to the evaporator 2. Hot water which is a heat source flows through the pipe 11. Then, the hot water flows into the evaporator 2. The working medium passes through the fourth pipe 10 and then the working medium flows into the evaporator 2. In the evaporator 2, the heat of the hot water is transferred to the working medium. As a result, the heated working medium evaporates. The evaporated working medium flows through the first pipe 7. Then, the working medium flows from the evaporator 2 into the turbine generator 3. The hot water whose temperature has dropped flows through the pipe 12. Then, the hot water is discharged.

The turbine generator 3 will be described later. The condenser 4 is a heat exchanger. The condenser 4 condenses the working medium by cooling the working medium using a cooling source. As the condenser 4, for example, a plate type heat exchanger can be used. The condenser 4 is not limited to the plate type heat exchanger. The condenser 4 may be a shell-and-tube heat exchanger. The condenser 4 may be a heat exchanger of another type. A pipe 13 and a pipe 14 are connected to the condenser 4. Cooling water which is a cooling source flows through the pipe 13. Then, the cooling water flows into the condenser 4. The working medium discharged from the turbine generator 3 flows through the second pipe 8. Then, the working medium flows into the condenser 4. In the condenser 4, the heat of the working medium is transferred to the cooling water. The cooled working medium is condensed. As a result, the working medium is liquefied. The liquefied working medium is discharged from the condenser 4. Then, the working medium flows through the third pipe 9. The cooling water which recovers the exhaust heat of the working medium in the condenser 4 flows through the pipe 14. Then, the working medium is discharged.

The circulation pump 5 circulates the working medium. As the circulation pump 5, for example, a turbo pump can be used. The working medium flows through the third pipe 9. Then, the working medium flows into the circulation pump 5. The working medium discharged from the circulation pump 5 flows through the fourth pipe 10. Then, the working medium is supplied to the evaporator 2.

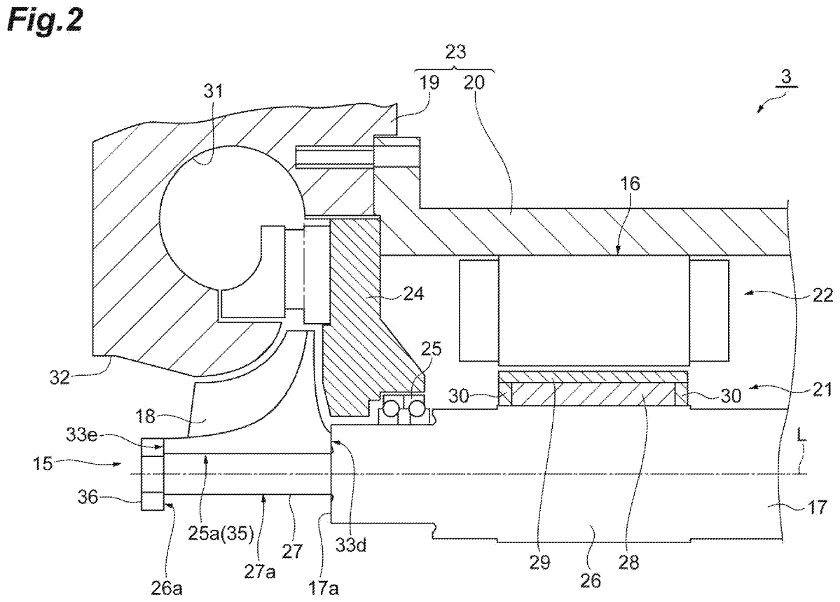

Next, the turbine generator 3 will be described with reference to FIG. 2. The turbine generator 3 includes a turbine 15, a generator 16, and a rotation shaft 17. The turbine 15 includes a turbine impeller 18 and a turbine housing 19. The generator 16 includes a generator housing 20, a rotor portion 21, and a stator portion 22. A housing 23 of the turbine generator 3 includes the turbine housing 19 and the generator housing 20. The turbine housing 19 is fixed to the generator housing 20. A partition wall 24 is provided between the turbine housing 19 and the generator housing 20. The rotation shaft 17 penetrates the partition wall 24. The rotation shaft 17 extends from the inside of the generator housing 20 to the inside of the turbine housing 19.

The rotation shaft 17 is rotatably supported by a pair of bearings 25. FIG. 2 illustrates only one bearing 25. One bearing 25 is held by the through-hole of the partition wall 24. The other bearing is held by a wall body on the side opposite to the partition wall 24 in the axial direction of the rotation shaft 17. The rotation shaft 17 includes a rotation shaft main body 26 which is disposed in the generator housing 20 and a small-diameter portion 27 (a bar-shaped member) which is disposed in the turbine housing 19. The rotation shaft main body 26 is disposed in the generator housing 20. The small-diameter portion 27 (the bar-shaped member) is disposed in the turbine housing 19. The outer diameter of the small-diameter portion 27 is smaller than the outer diameter of the rotation shaft main body 26. A step surface 17a is formed in the rotation shaft 17. The step surface 17a is an end surface of the rotation shaft main body 26.

The rotor portion 21 and the stator portion 22 are disposed in the generator housing 20. The rotor portion 21 includes a magnet 28 and a cylindrical member 29. The magnet 28 is attached to the outer periphery of the rotation shaft main body 26. The magnet 28 has, for example, a cylindrical shape. The magnet 28 is attached to the rotation shaft main body 26. The cylindrical member 29 covers the magnet 28. The cylindrical member 29 is attached to the magnet 28 so as to cover the outer peripheral surface of the magnet 28. An end surface of the magnet 28 is covered by a ring member 30 in the direction of the axis L of the rotation shaft 17. The ring member 30 is disposed on both sides of the magnet 28 in the direction of the axis L of the rotation shaft 17.

The stator portion 22 is held in the generator housing 20 to surround the rotor portion 21. The stator portion 22 includes a cylindrical core portion and a coil portion. The core portion is disposed to surround the rotor portion 21. The coil portion is formed by winding a conductor wire around the core portion. The rotor portion 21 rotates together with the rotation shaft 17. As a result, a current flows through the coil portion of the stator portion 22. Accordingly, the turbine generator 3 generates power.

A base end portion of the small-diameter portion 27 is connected to the rotation shaft main body 26. The axis of the rotation shaft main body 26 and the axis of the small-diameter portion 27 are coaxial with each other. The turbine housing 19 is provided with a suction port (not illustrated), a scroll portion 31, and a discharge port 32. The suction port opens in a direction intersecting the extension direction of the rotation shaft 17. The scroll portion 31 communicates with the suction port. The scroll portion 31 is formed to orbit in the circumferential direction of the rotation shaft 17. The discharge port 32 opens in the direction of the axis L of the rotation shaft 17.

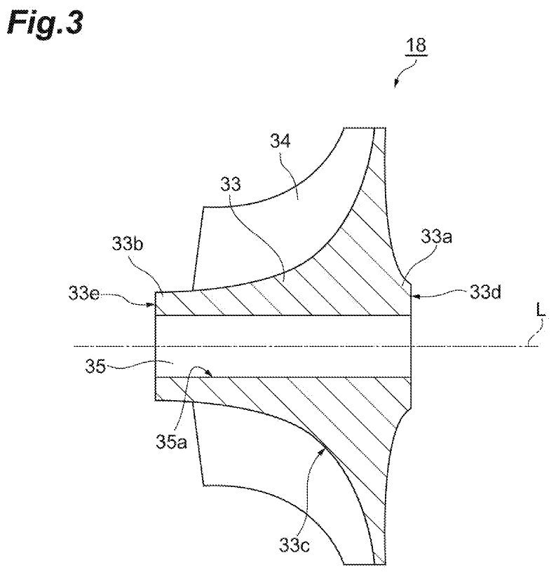

The turbine impeller 18 includes, as illustrated in FIG. 3, an impeller main body 33 and a vane 34. A through-hole 35 is formed in the impeller main body 33 to penetrate in the direction of the axis L. The impeller main body 33 includes a base end side boss portion 33a and a tip side boss portion 33b. The base end side is the side of the rotation shaft main body (the right side of the drawing). The tip side is the side on the side opposite to the rotation shaft main body (the left side of the drawing). The outer diameter of the impeller main body 33 decreases from the base end side toward the tip side. In a cross-section taken along the axis L, an outer peripheral surface 33c of the impeller main body 33 is curved to be connected from a direction along the radial direction to a direction along the direction of the axis L. The vane 34 protrudes outward from the outer peripheral surface 33c of the impeller main body 33. The turbine impeller 18 includes a plurality of vanes 34 which are arranged to be separated from each other in the circumferential direction.

As illustrated in FIG. 2, the small-diameter portion 27 is inserted through the through-hole 35 of the turbine impeller 18. A male screw portion is formed in the tip portion of the small-diameter portion 27. A nut 36 is attached to the male screw portion. When the nut 36 is fastened, the turbine impeller 18 is pressed against the rotation shaft main body 26. The turbine impeller 18 is attached and fixed to the rotation shaft 17. An end surface of the base end side boss portion 33a is in close contact with the end surface of the rotation shaft main body 26 in the direction of the axis L. An end surface of the tip side boss portion 33b is in close contact with an end surface of the nut 36 in the direction of the axis L. The small-diameter portion 27 is fitted to the through-hole 35. An inner peripheral surface of the through-hole 35 is in close contact with an outer peripheral surface of the small-diameter portion 27. The turbine impeller 18 may be attached to the rotation shaft 17 by other methods.

In the turbine 15, the working medium sucked from the suction port flows to swirl in the scroll portion 31. The working medium flows from the outside of the radial direction into the turbine impeller 18. The working medium is introduced to the outer peripheral portion of the turbine impeller 18. In other words, the working medium is introduced to the outside of the radial direction of the turbine impeller 18. The working medium is introduced to the base end side of the turbine impeller 18 in the direction of the axis L. The working medium hits the plurality of vanes 34. As a result, the turbine impeller 18 rotates around the axis L. The working medium flows along the outer peripheral surface 33c of the impeller main body 33 while swirling around the axis L. The working medium is derived from the tip side. Then, the working medium flows along the axis L and then is discharged through the discharge port 32.

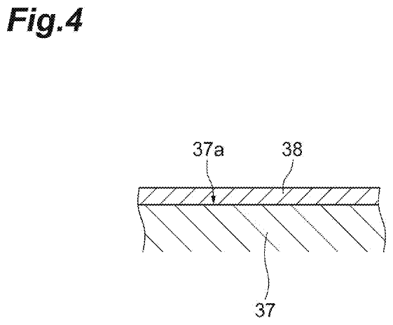

A base material 37 (see FIG. 4) of the turbine impeller 18 is formed of aluminum. The base material 37 of the turbine impeller 18 may be an aluminum alloy. The aluminum alloy contains aluminum as a main element and contains other elements. The impeller main body 33 and the vane 34 are integrally formed of the same material.

The turbine impeller 18 includes, as illustrated in FIG. 4, a coating 38 (an anti-erosion coating). The coating 38 covers a surface 37a of the base material 37. The coating 38 is, for example, a plating layer containing nickel and phosphorus. The coating 38 is formed on the outer peripheral surface 33c of the impeller main body 33 and a surface of the vane 34. The film thickness of the coating 38 can be, for example, 10 μm or more. The coating 38 is not formed on an end surface 33d of the base end side boss portion 33a of the impeller main body 33. The coating 38 is not formed on an end surface 33e of the tip side boss portion 33b of the impeller main body 33. The coating 38 is not formed on an inner peripheral surface 35a of the through-hole 35 of the impeller main body 33. The coating 38 may be formed on the rear surface portion of the impeller main body 33. In other words, the coating 38 may be formed on the surface on the side opposite to the tip side of the impeller main body 33.

The hardness of aluminum which is the base material 37 may be, for example, a Vickers hardness HV100 or more. Further, the hardness of aluminum may be, for example, a Vickers hardness HV160 or less. The hardness of the coating 38 may be, for example, a Vickers hardness HV500 or more. The hardness can be obtained by performing, for example, a Vickers hardness test (JISZ2244). Further, the hardness of the coating 38 may be obtained by converting the results of other hardness tests into a Vickers hardness. The hardness test of the coating 38 can be performed, for example, in a state in which the coating 38 is formed on the base material 37.

The plating layer which is the coating 38 is formed by, for example, electroless plating. Next, a method of forming a nickel-phosphorus plating will be described. As a method of forming a nickel-phosphorus plating, for example, a zinc replacement method can be adopted. As pretreatment, degreasing, etching, and pickling of the base material 37 are performed. After the pretreatment, the base material 37 formed of aluminum is immersed in the zinc replacement solution. Accordingly, zinc is replaced and deposited on the surface of aluminum. Next, aluminum is immersed in an electroless nickel-phosphorus plating solution. As a result, the plating layer is formed. Subsequently, a heat treatment is performed. Accordingly, the coating 38 which is a nickel-phosphorus plating can be formed on the surface 37a of the base material 37. A masking is performed on the end surface 33d of the base end side boss portion 33a of the impeller main body 33, the end surface 33e of the tip side boss portion 33b, and the inner peripheral surface 35a of the through-hole 35 which are portions not provided with the coating 38. Due to this measure, the plating layer is not formed on these portions.

In the binary power generator 1, aluminum is adopted as the base material 37 of the turbine impeller 18. Thus, the turbine impeller 18 can be decreased in weight. As a result, the turbine impeller 18 can be rotated at a high speed. The rotation speed of the turbine impeller 18 can be, for example, 20,000 rpm or more. Further, the rotation speed of the turbine impeller 18 can be, for example, 30,000 rpm or less.

In the binary power generator 1, there is low possibility that the liquid droplets of the working medium may flow into the turbine impeller 18 during the normal operation. In the binary power generator 1, it is possible to prevent the liquid droplets from flowing into the turbine impeller 18 in an emergency by providing, for example, a bypass passage that bypasses the turbine 15. The binary power generator 1 may prevent the liquid droplets from flowing into the turbine impeller 18 according to other methods.

The turbine impeller 18 of the present disclosure is provided with the coating 38. Thus, even when the liquid droplets flow into the turbine impeller 18, the liquid droplets contact the coating 38 before the base material 37. As a result, the damage to the surface 37a of the base material 37 due to erosion is suppressed. The hardness of the coating 38 is higher than that of the base material 37. That is, the coating 38 is harder than the base material 37. Thus, even when the liquid droplets hit the coating 38, the amount of the base material hardly decreases. As a result, since the damage of the base material 37 is suppressed, a decrease in the rotation stability of the turbine impeller 18 is suppressed. Thus, the reliability of the turbine generator 3 can be improved.

The coating 38 is not formed on the end surfaces 33d and 33e of the impeller main body 33 of the turbine impeller 18. Accordingly, the surface roughness of the end surfaces 33d and 33e can be easily managed. Thus, the surface roughness of the end surfaces 33d and 33e can be easily managed at a design value. Further, an appropriate frictional force can be generated between the end surface 33d of the impeller main body 33 and the step surface 17a of the rotation shaft 17 in close contact with the end surface 33d. Similarly, an appropriate frictional force can be generated between the end surface 33e of the impeller main body 33 and an end surface 36a of the nut 36 in close contact with the end surface 33e. Thus, the displacement of the turbine impeller 18 with respect to the rotation shaft 17 in the circumferential direction can be suppressed. As a result, a decrease in the rotation stability of the turbine impeller 18 is suppressed.

The coating 38 is not formed on the inner peripheral surface 35a of the through-hole 35 of the impeller main body 33 of the turbine impeller 18. As a result, the dimension of the inner peripheral surface 35a of the through-hole 35 can be easily managed. Thus, the dimension of the inner peripheral surface 35a of the through-hole 35 can be easily managed at a design value. Further, it is possible to suppress a decrease in fitting accuracy of the through-hole 35 and the small-diameter portion 27 inserted through the through-hole 35.

The present disclosure is not limited to the above-described embodiment and can be modified into various forms as below within the scope not departing from the spirit of the present disclosure.

In the above-described embodiment, the nickel-phosphorus plating is formed as the coating 38. However, the coating 38 may be an anti-erosion coating different from the nickel-phosphorus plating. The coating may be a hard coating (an anti-erosion coating) formed on the surface 37a of the base material 37. The hard coating is formed by, for example, chemical vapor deposition (CVD) and physical vapor deposition (PVD).

In the above-described embodiment, the turbine impeller 18 in which the coating 38 is not formed on the end surfaces 33d and 33e has been described. However, the coating 38 may be formed on the end surfaces 33d and 33e. For example, the coating may be formed on a portion not contacting the nut 36. The coating may be formed on a portion not contacting the step surface 17a of the rotation shaft 17. Similarly, the coating may be formed on the inner peripheral surface 35a of the through-hole 35. The outer peripheral surface 33c of the impeller main body 33 may include a portion not provided with the coating. The surface of the vane 34 may include a portion not provided with the coating.

In the above-described embodiment, the binary power generator 1 including the turbine generator 3 has been described. The turbine generator 3 can be used as other power generators. The application of the turbine impeller 18 is not limited to the turbine generator 3. The turbine impeller 18 can be applied to other rotating machines such as a compressor (a compressing machine). For example, when the turbine impeller 18 of the present disclosure is applied to other compressing machines, the rotation speed of the turbine impeller 18 may be 20,000 rpm or more and 60,000 rpm or less. The rotation speed of the turbine impeller 18 may be appropriately changed in response to the application.

### REFERENCE SIGNS LIST

1: binary power generator, 3: turbine generator, 18: turbine impeller, 33d: end surface of base end side boss portion, 33e: end surface of tip side boss portion, 35: through-hole, 35a: inner peripheral surface, 37: base material, 37a: surface, 38: coating (anti-erosion coating), L: axis.

1. A turbine impeller comprising:
a base material which contains aluminum as a main element; and
an anti-erosion coating which covers a surface of the base material.

2. The turbine impeller according to claim 1,
wherein the anti-erosion coating is a plating layer containing nickel and phosphorus.

3. The turbine impeller according to claim 1,
wherein a hardness of the base material is a Vickers hardness HV100 or more and HV160 or less.

4. The turbine impeller according to claim 1,
wherein a hardness of the anti-erosion coating is HV500 or more.

5. The turbine impeller according to claim 1,
wherein a through-hole is formed in the base material to penetrate in an axial direction, and
wherein the anti-erosion coating is not formed on an end surface of the base material in the axial direction.

6. The turbine impeller according to claim 1,
wherein a through-hole is formed in the base material to penetrate in an axial direction, and
wherein the anti-erosion coating is not formed on an inner peripheral surface of the through-hole.
